(19) United States
(12) Patent Application Publication
(10) Pub. No.: US 2013/0169706 A1
(43) Pub. Date: Jul. 4, 2013

(54) Methods for Measurement of Microdisplay Panel Optical Performance Parameters

(71) Applicants: Adam W. Harant, Louisville, CO (US); Brion Koprowski, Longmont, CO (US); Eric S. Marcum, Boulder, CO (US)

(72) Inventors: Adam W. Harant, Louisville, CO (US); Brion Koprowski, Longmont, CO (US); Eric S. Marcum, Boulder, CO (US)

(21) Appl. No.: 13/338,873

(22) Filed: Dec. 28, 2011

(51) Int. Cl. G09G 5/10; G09G 5/02; G06F 3/038

(52) U.S. Cl. 345/697; 345/204; 345/690

(57) ABSTRACT

A testing system and method are described for use in testing a sequential display having a liquid crystal microdisplay panel. A channel is used for displaying a test image while a parameter of the panel is measured and another channel is used for compensating for DC errors introduced by the test image into the microdisplay panel.

### BACKGROUND

The present invention is generally related to the field of sequential displays, and, more particularly, to characterizing the performance of such displays.

It is often desirable to test a microdisplay panel in order to characterize its performance. Applicants recognize that the panel itself can influence test results, as will be described in detail herein. There are a number of competing technologies in the field of modern displays. One type of modern display is the field sequential display using a ferroelectric liquid crystal on silicon (FLCOS) pixel array. The pixel array of the FLCOS display is capable of extremely fast switching such that it is ideally suited to the display of real time video. Some of these displays have been configured for illumination by LEDs. These displays can offer a bright and accurate image across a wide range of operating conditions from a very small package. Projection type FLCOS display arrangements with LED-based light engines have been successfully integrated in portable, battery powered devices such as, for example, cellular telephones.

A field sequential display generally presents video to a viewer by breaking the frames of an incoming video stream into subframes of individual red, green and blue subframes. Only one color subframe is presented to the viewer at a time. That is, the pixels of the pixel array can be illuminated at different times by an appropriate color of light associated with the red, green and blue subframes in a way that produces an image with varied color intensity, which can also be referred to as a grayscale image, for each subframe. The color subframes can be presented to the viewer so rapidly, however, that the eye of the viewer integrates the individual color subframes into a full color image. In the instance of an incoming video stream, the processing for purposes of generating the subframes is generally performed in real time while the pixels of the display are likewise driven in real time.

The foregoing examples of the related art and limitations related therewith are intended to be illustrative and not exclusive. Other limitations of the related art will become apparent to those of skill in the art upon a reading of the specification and a study of the drawings.

### BRIEF DESCRIPTION OF THE DRAWINGS

FIG. 1 is a diagrammatic illustration of an embodiment of a test system and sequential display in block diagram form that is configured for operation according to the present disclosure.

FIG. 2 is a diagrammatic illustration of embodiments of certain components of the sequential display operable in conjunction with the test system of FIG. 1.

FIG. 3 is a perspective view of embodiments of certain components of the display of FIG. 2, shown here to illustrate features of their operation.

FIG. 4 is a diagrammatic illustration of an embodiment of a video stream made up of frames used by the display of FIGS. 1-3 to produce a series of color subframes and further demonstrates a hypothetical set of pixel values, for explanatory purposes, presented on the display of FIGS. 1-3 for a subframe.

FIG. 5 is a graphical representation of an embodiment of a test image usable in the test system of FIG. 1.

FIG. 6 is a graphical representation of another embodiment of a test image usable in the test system of FIG. 1.

FIG. 7 a diagrammatic illustration of another embodiment of a test system and sequential display in block diagram form that is configured for operation according to the present disclosure.

FIG. 8 is a diagrammatic illustration of yet another embodiment of a test system and sequential display in block diagram form that is configured for operation according to the present disclosure.

FIG. 9 is a diagrammatic illustration of an apparatus for use with a test system according to the present disclosure for in situ video test frame generation.

FIG. 10 is a flow diagram that illustrates an embodiment of a method for the operation of a test system according to the present disclosure for testing.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the generic principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the figures, and is in no way intended as being limiting.

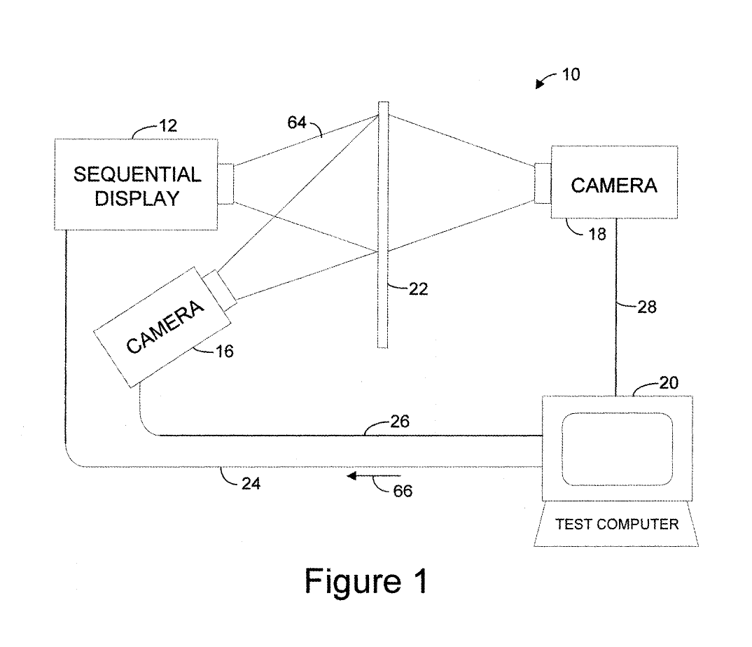

Attention is now directed to the figures wherein like reference numbers may refer to like components throughout the various views. FIG. 1 is a diagrammatic representation of an optical test system, generally indicated by reference number 10. Optical test system 10 can be used for testing a sequential display 12, which can be, for example, a nematic-based liquid crystal system or a DLP/micro-mirror system or others. Test system 10 includes a front camera 16, a rear camera 18, a test computer 20 and a projection screen 22. Test computer 20 can be connected to the sequential display over a test cable 24 for transfer of control and/or data signals between the test computer and the sequential display. Test computer 20 can also be connected to front and rear cameras 16 and 18 using camera cables 26 and 28, respectively, for transfer of control and/or data signals between the test computer and the cameras.

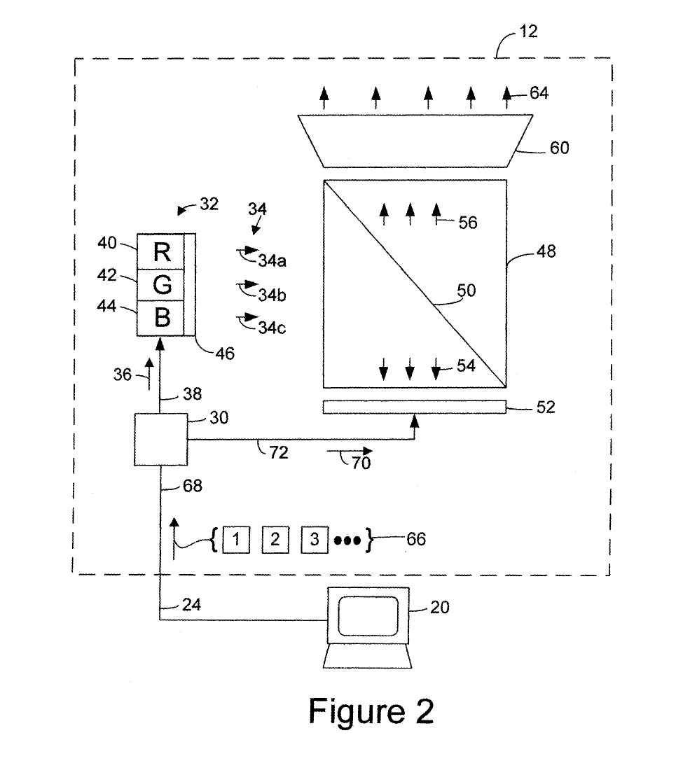

Referring now to FIG. 2 in conjunction with FIG. 1, sequential display 12 can include a controller 30 that can be connected to a light source 32 which emits polarized light 34 which is indicated by arrows. Light source 32 can be driven by the controller with a light source control signal 36 over a data line 38 to selectively emit colored light. Light source 32 can include a red LED 40, green LED 42 and a blue LED 44 for emitting red light 34a, green light 34b and blue light 34c, respectively. Other light source arrangements can also be used such as, for example, an arrangement where multiple LEDs of one or more colors are used. Light source 32 can also include a polarizer 46 for polarizing the light from the LEDs. Polarized light 34 supplied by light source 32 can enter a polarizing beam splitter (PBS) 48. A beam splitting hypotenuse face 50 of the PBS reflects the polarized light onto a display panel such as, for example, an FLCOS microdisplay panel 52. The reflected polarized light is indicated by the reference number 54 and is represented using arrows. The microdisplay panel selectively modulates and reflects the incoming light to produce modulated output light 56. In an embodiment, when a given pixel, (also called a cell), is in an off state, the polarization of light reflected from the given pixel is rejected by PBS 46 whereas when the given pixel is an on state, the polarization of the reflected light is switched and therefore passes through the PBS as modulated output light 56. The modulated output light can be received by a projection lens arrangement 60 and emitted as projection light 64 which can be incident upon any suitable surface such as, for example, projection screen 22 shown in FIG. 1, for purposes of viewing and/or testing.

Controller 30 generates signals based on an input signal 66 received on an input signal line 68. In the present embodiment, input line 68 is connected to test cable 24 to receive the input signal from test computer 20. Input signal 66 can be an incoming video stream that is made up of frames, three of which are shown and labeled as 1, 2 and 3. Based on the information in the frames, controller 30 provides panel control signal 70 to microdisplay panel 52 over a panel control line 72 to selectively turn the pixels of the panel on and off for modulating polarized light 34; and provides light source control signal 36 over data line 38 to control the light source.

The present disclosure describes in detail the use of a sequential display in the form of a projection light engine for; however, the teachings herein are not limited to projection light engines but are equally applicable with respect to any form of sequential display having a microdisplay panel. It is noted that optical elements such as, for example, various lens arrangements can form part of sequential display 12 as will be recognized by those of ordinary skill in the art, however, these elements have not been shown for purposes of illustrative clarity. While the present disclosure remains applicable to any suitably shaped display having any suitable aspect ratio, the disclosure will consider the use of a 16 by 9 display. Each of 9 rows of pixels includes 16 pixel columns, as illustrated, to make up the 16 by 9 display. An actual display will generally include far more pixels such as, for example, an array of 1280×720 pixels for a high definition 16 by 9 display (720p), or an array of 720×480 for a standard definition display (480p). With respect to PBS 48, it should be appreciated that other embodiments can use another suitable form of polarization dependent reflective arrangement such as, for example, a reflective polarizer.

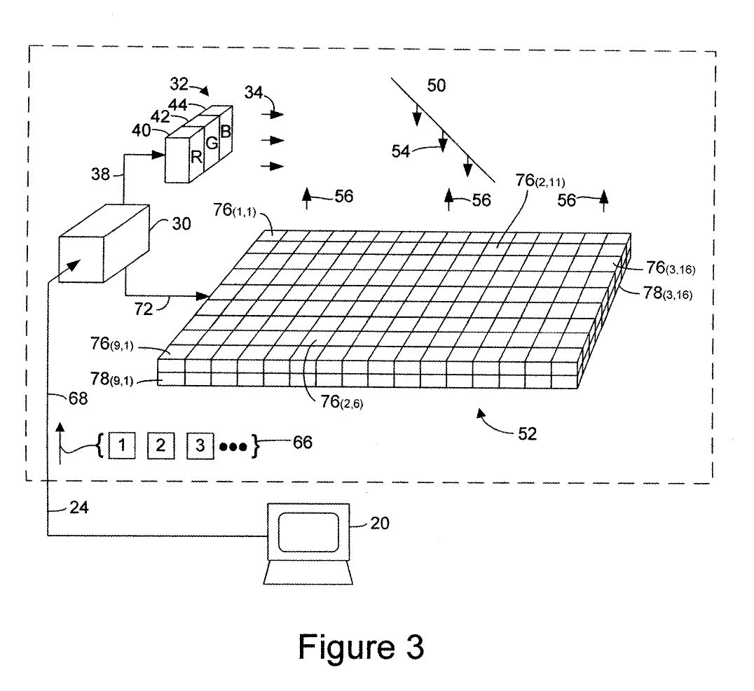

Referring to FIG. 3 in conjunction with FIG. 2, the former diagrammatically illustrates components of sequential display 12 that are controlled by controller 30. In particular, controller 30 is in electrical communication with light source 32 and microdisplay panel 52. In FIG. 3, microdisplay panel 52 is shown in a diagrammatic perspective view to illustrate the array of pixels that is made up of n columns and k rows of pixels, (in this instance 16 columns and 9 rows), several of which are indicated by the reference number 76 and which may be referred to individually herein with reference to position in the array with a designation format of (column#, row#). Each of the pixels in the array has an associated pixel driver (PD) that is used for driving the state of the pixel under the control of controller 30. Selected pixel drivers are shown in block form and are indicated by the reference number 78 with an appended array position designation using (column#, row#) of the pixel that the pixel driver is driving.

Microdisplay panel 52 shown in the present embodiment can be a reflective type display as is known by a person having ordinary skill in the art of microdisplay panels. The microdisplay panel can have a layer of glass with a conductive coating of Indium-tin-oxide (ITO) over liquid crystal on silicon with a reflective pixelated surface. An electric field can be generated between the ITO glass and the silicon by the panel's electrical system, which includes the pixel drivers, to switch the liquid crystal between bright and dark states. Depending on the type of liquid crystal display and the application, different drive algorithms can be used to control the switching of the drive voltage electric field and the liquid crystal. Liquid crystal displays can have ions dissolved in the liquid crystal. If the drive algorithm creates a modulated electric field that results in an overall DC field not equal to zero, the residual DC field can cause the ions to move toward one electrode or the other. The amount of DC imbalance in the DC field can be referred to as DC offset. Any DC field created by ions in the liquid crystal will counteract whatever field is being generated by the display panel.

A liquid crystal microdisplay panel can be driven with or without DC balance. Some panels can exhibit desirable characteristics when driven without DC balance, also called DC imbalanced. For instance, some liquid crystal display panels have to be driven DC imbalanced to achieve higher panel brightness. The actual amount of DC imbalance across a pixel showing a particular color depends on the type of liquid crystal display as well as other factors. The effect of DC balance on the panel performance can change depending on specifics of the panel. For example, the effects of DC imbalance are different for ferroelectric liquid crystal displays as compared to twisted nematic thin-film transistor type displays.

Among other issues introduced by unwanted DC imbalance, when one or more pixels are repeatedly driven with a drive voltage that is either relatively more negative or positive over a period of time, the pixels can tend to exhibit ghosting effects caused by the pixels having a slower response to drive voltage changes. Another problem caused by DC imbalance is image sticking. Image sticking is characterized by an image or portion of an image remaining on the microdisplay panel after having been displayed over a long period of time even though the panel control signal has been changed to display a different image. Image sticking can be more prevalent when the panel is used for displaying text or other images where there is a distinct separation between brightness levels of adjacent pixels. DC imbalance can also cause a drift in the intensity of color represented by one or more pixels. For instance, with a conventional method, continually driving a microdisplay panel with an all white image can result in the image growing dimmer over time. Similarly, with the conventional method, continually driving the microdisplay panel with an all black image can result in the image growing brighter over time. These changes in brightness caused at least in part by DC imbalances can be referred to as drift which can be detected and characterized by the testing methods described herein.

One effect of the DC imbalance of the electric field driving the panel is that it can cause ions in the panel to migrate to counteract the DC field, therefore having a capacitive effect. A complementary effect is that the electric field created by the ions will add or subtract from the drive field. The switching speed of the panel (i.e., how long it takes to switch from dark to bright or vice versa) can be dependent on the drive field. If the field is reduced by the ionic field from the DC imbalance, the switching speed can be reduced. This could result in visual artifacts when driving at higher frequencies (240 Hz vs. 60 Hz), or a variety of conditions, such as reduced throughput and contrast. In one DC imbalanced drive mode, a ferroelectric liquid crystal panel showing white can slowly reduce brightness over time because of the positive DC imbalance created by the drive algorithm.

The modulation of the electric field by the display's drive algorithm can change depending on the brightness level that the display is showing, so that the brightness or grayscale level of an individual pixel can change the DC imbalance that is created in that pixel. In one display algorithm, driving a pixel to display a bright color or to produce the appearance of white by the combination of RGB will cause that pixel to have a positive DC imbalance. With that same algorithm, driving the pixel to display a dark color or to produce the appearance of black by the combination of RGB will cause the pixel to have a negative DC imbalance. The sign and magnitude of the generated DC imbalance can depend on how the particular panel is designed to operate as will be understood to a person of ordinary skill in the art.

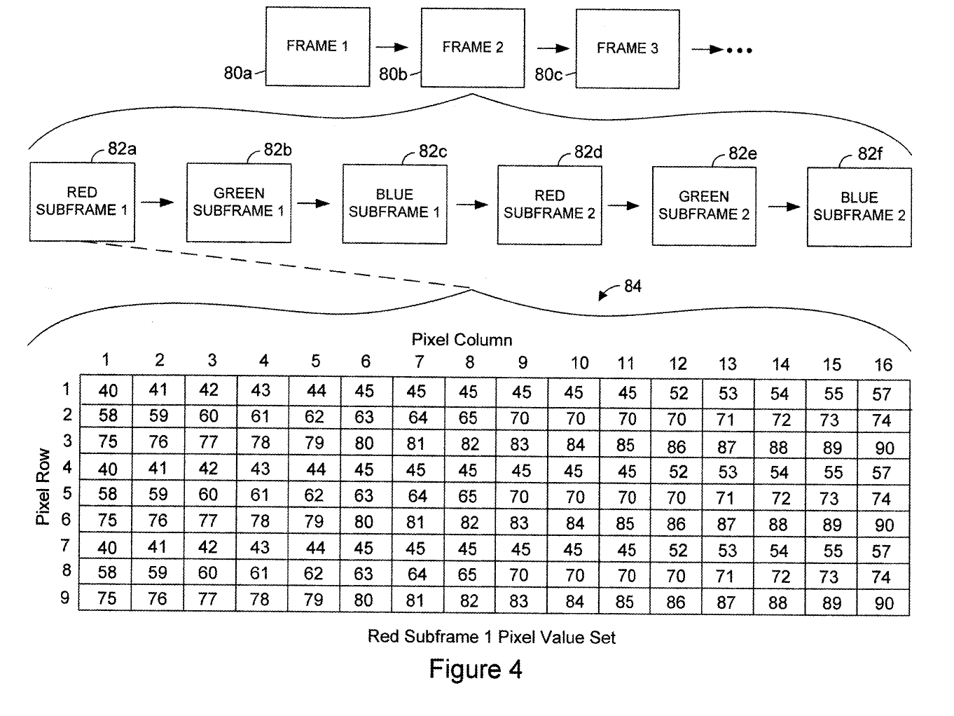

Attention is now directed to FIG. 4 which diagrammatically illustrates three sets of frame data labeled as Frame 1-3, indicated by reference numbers 80a, 80b and 80c, taken from video stream 66 (FIGS. 1-3). Each set of frame data can be used to represent a full color frame image in the video data stream by rapidly displaying a series of subframe images from subframe data 82, such as subframe data 82a-f, contained in each of the frame data sets. The controller uses the subframe data to control the light source 32 and microdisplay panel 52 in coordination with one another to produce each of the subframe images. Each division of time of the frame in which control over the microdisplay panel can be exercised can be referred to herein as a channel. In the embodiment shown by FIG. 4, frame 2 includes 6 color subframes that are labeled as Red Subframe 1, Green Subframe 1, Blue Subframe 1, Red Subframe 2, Green Subframe 2 and Blue Subframe 2. Each of the 6 subframes can be considered to be a channel in which control over the microdisplay panel can be exercised to modulate incident light from one of the LEDs. As is discussed in further detail below, each channel does not necessarily have to correspond to a subframe of the frame. Each channel can be a separate control of the microdisplay panel that is not normally used when displaying video.

In the present example, microdisplay panel 52 is shown having a pixel array that is limited to 144 pixels in a 16 by 9 arrangement for purposes of illustrative clarity. A specific grayscale pixel value set 84 is given within the area of each pixel, by way of example, for Red Subframe 1 (subframe data 82a). It is noted that these pixel values are not derived from an actual video frame but are hypothetical and have been selected for purposes of illustrating the methods that are being brought to light by the present disclosure. One of ordinary skill in the art, however, will appreciate that there is no difference with respect to the application of these methods to actual video/subframe data. In the present example, 7 bit grayscale pixel values are in use such that the grayscale value for any given pixel can potentially be any value in the range of 0-127, where a grayscale value of zero can be as dark as possible and a grayscale value of 127 can be as bright as possible. Any suitable number of grayscale pixel values can be used. For purposes of the present disclosure, grayscale values for each pixel can be operationally achieved solely by switching each pixel between an OFF state and an ON state such that light that is reflected in one state is opposite in polarization to the reflected light in the other state. In some embodiments, however, the intensity of light emitted by light source 32 can be modulated in cooperation with pixel switching to achieve grayscale values while remaining within the scope of the teachings herein.

Still referring to FIG. 4, when a pixel has a grayscale value that is relatively low, such as pixel 1, 1 which has a grayscale value of 40, that pixel is only turned on for 40 out of the possible 128 cycles of the Red Subframe 1 and is therefore seen as being relatively dark. Correspondingly, the pixel 1, 1 is subjected to a negative drive voltage to keep the pixel in the off state more than it is subjected to a positive drive voltage to keep the pixel on. Therefore if pixel 1, 1 is driven with the grayscale value of 40 over a period of subframes or frames, pixel 1, 1 will exhibit a negative DC imbalance. By way of comparison, pixel 16, 3 has a grayscale value of 90 which is relatively high and is therefore turned on for 90 out of the possible 128 cycles of the Red Subframe 1. Pixel 16, 3 is therefore relatively light in comparison to pixel 1, 1 and is subjected to a positive voltage more than a negative voltage. If pixel 16, 3 were to have the grayscale value of 90 over a period of time, pixel 16, 3 would exhibit a positive DC imbalance. To DC balance a particular pixel, for every millisecond that the pixel is driven with an electric field in a positive direction, the liquid crystal has to be driven for a millisecond with an electric field in a negative direction.

Testing is used for determining optical parameters of microdisplay panels. A conventional testing procedure can involve driving all of the channels of the panel to produce a black image for some period of time during which light output and/or other parameters are measured before switching the panel to produce the appearance of a white image. The white image can then be measured for light output or other desired parameter for the same period of time. In this testing procedure, an attempt is made to maintain the overall DC balance of the panel by driving the panel first to a selected one of the black image or the white image and then to the other one of the black image or the white image. Performance of LCOS panels is dependent on the type of picture that is being displayed. Showing the same image on the panel for a long period of time, especially an image with hard edges like text, the image can burn-in the screen over time. One example illustrating burn-in is ATM screens. More damage or image sticking occurs if the same image is shown over a long period of time as compared to showing a video on the screen. In addition, showing very dark video and showing very light video can change the way that the panel behaves in reliability tests over time. The conventional testing procedure described above, which uses only a black image and a white image, is not suitable for testing the microdisplay panel for reliability or other parameters that can result from the display of various types of video images. In a conventional video display system, all subframes generally are used to display video. Further, in a conventional video test the test image is displayed on all of the channels.

In contrast to the above, conventional test procedure, a testing procedure according to the present disclosure can be used for testing the microdisplay panel while the panel is driven with various types of video images. This allows for a determination of how particular types of video affect the microdisplay panel without interference from the test image. In an embodiment a testing procedure for testing microdisplay panels can be implemented in which one channel in a multiple channel microdisplay device is replaced with a test image, while one or more of the other channels are used to compensate for DC imbalances introduced by the test image. In a testing procedure, the channel on which test image is applied can be illuminated by the light source corresponding to the channel while the light sources for the other channels remain off. This allows only the test image to be captured by the testing equipment while still using the other channels to compensate for the DC imbalances introduced by the test image thereby allowing for the determination of how particular types of video affect the microdisplay panel without interference from the test image.

For instance, in FLCOS technology, changes in the DC balance of a pixel introduced by a test image can cause changes in the switching time, cone angle and other parameters, which can ultimately lead to a change in the accuracy of the color being displayed in non-test channels. By using the non-test channels for compensating for DC imbalances introduced by the test image the pixels are only subjected to the same amount of DC imbalance during testing that would be introduced by the raw video alone. This way, changes in switching time and cone angle (or other properties) can be identical to the raw video during the testing procedure. Throughput/brightness and contrast measurements can be dependent on DC imbalance in the panel. By introducing DC imbalance during testing which matches the DC imbalance that occurs during a typical video, the measurements will more accurately reflect the brightness and contrast of the panel when video footage is actually watched with the display projector product.

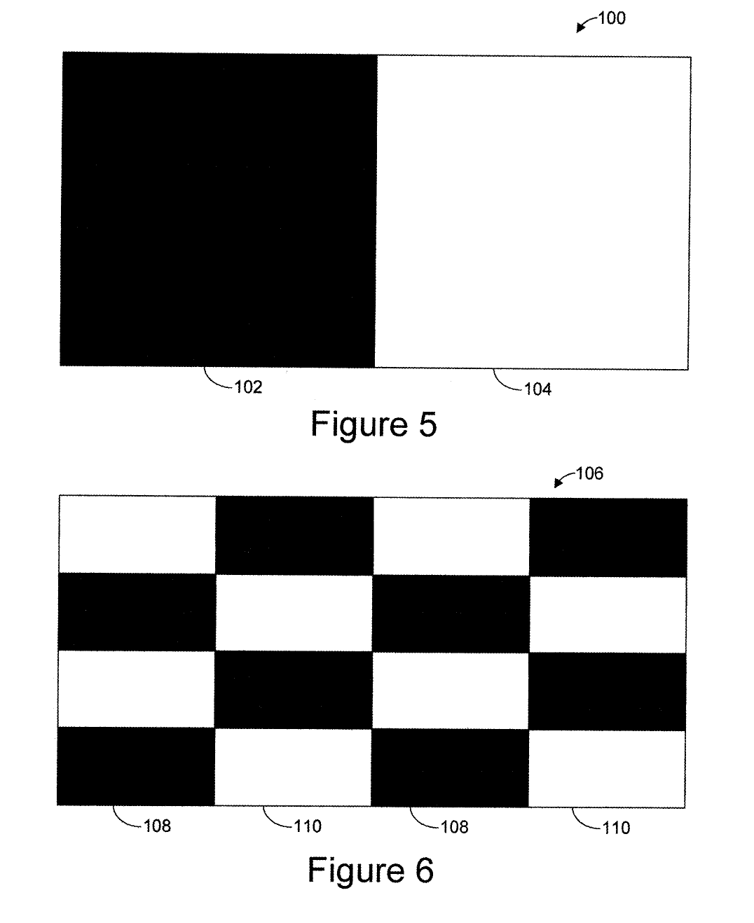

FIG. 5 is illustrative of a test image 100 which can be a bisected test image with the left hand half of the frame 102 dark and the right hand side of the frame 104 bright. For example, when the test image is used on the green channel, the bright side of the frame will be bright green. The bisected test image allows for the simultaneous measurement of contrast and brightness/throughput from a single captured image. The bright region on the right hand side of the image can be used for the measurement of the maximum throughput and brightness while the black region on the left hand side of the image allows for the measurement of the dark level and the contrast when combined with the bright level data. Other test images can also be used such as, for instance, test image 106 in FIG. 6 which includes a checker-type pattern of alternating dark areas 108 and light areas 110. Other test images can be used for measuring dark level, contrast and/or brightness and other parameters of the microdisplay panel.

Referring back to FIG. 1, test computer 20 can drive sequential display 12 to project video test data images interspersed with video subframe images onto projection screen 22 by rapidly displaying the test and video images in sequence. The video pre-processing for inserting the test image into one of the channels and for modifying the subframe data in the other channels to compensate for the DC bias can be performed, by way of example, using a variety of PC-based video software applications or video compositing hardware. While one or more iterations of a frame are projected onto the screen, cameras 16 and 18 detect the image and send the detected information back to the test computer for processing. The cameras can be set to detect the light from the projection screen for a specific amount of time. For instance, the cameras can be set to detect the light for a single frame, multiple frames, or for a set amount of time, such as two seconds, which at 60 Hz is 120 frames. The detection time can be dependent on the test image. For instance, it may take longer to obtain useful test data from a dark test image than from a brighter test image. In the present embodiment, the test computer can be used to produce the test image and to compensate for the test image and to supply the test image for display on the channel. In an embodiment, the test image can be part of an integral test system that is part of the microdisplay device.

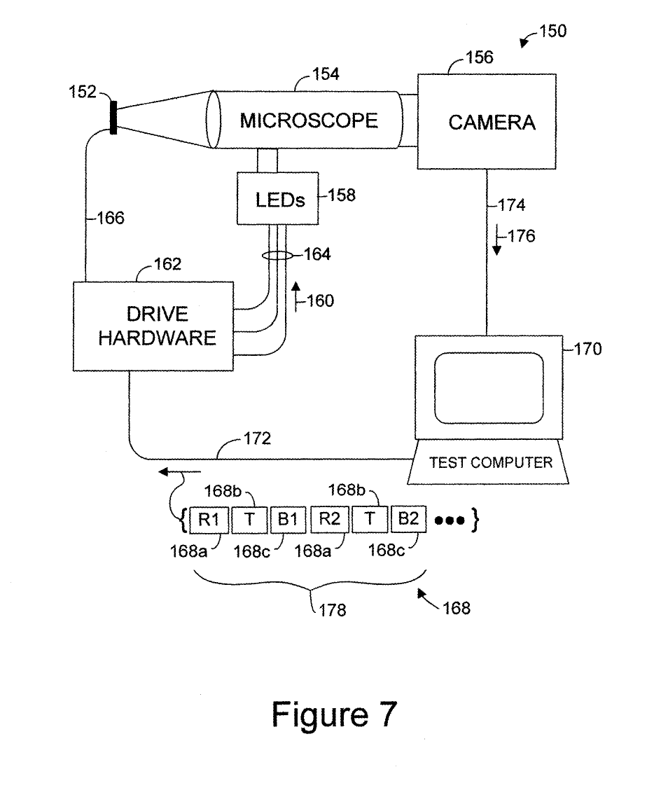

Turning now to FIG. 7, another embodiment of a microdisplay optical testing system is generally indicated with reference number 150. In this embodiment, a microdisplay 152 can be imaged using a microscope 154 that is equipped with a test camera 156. The microscope can include LED light sources 158 that are red, green and blue which can be driven by trigger signals 160 by drive hardware 162 through light source lines 164. The drive hardware can also be used for synchronizing the different colored lights in the light source with the microdisplay. The drive hardware can provide the power and video signal to the microdisplay through a drive line 166. For frame sequential display algorithms, each LED color can be triggered individually, so that the displayed red, green and blue subframes of video data can be illuminated only by the corresponding LED. Using this arrangement, the video data displayed on the microdisplay panel can be imaged by digital camera 156 connected to the microscope. In an embodiment of the test method, only subframes containing the test image data will be illuminated. For example, if the green channel contains the test data, only the green LED will be utilized. In the testing system shown in FIG. 7, video and test data 168 can be supplied from test computer 170 through a test cable 172. Optical test information 174 can be sent from the camera to the test computer using a camera cable 176 in red, green and blue channels. A frame 178 of video and test data 168 can include red subframe data 168a for red subframe images 1 and 2, test subframe data 168b for test images, and blue subframe data 168c for blue subframe images 1 and 2 for driving the red, green and blue channels, respectively.

Test image 100, 106 or others can be used to replace one of the red, the green or the blue channels. In an embodiment shown in FIG. 7 the appearance of a composite RGB frame image can be produced by subframe image data 168a and 168c and test image data 168b. By driving the red channel with red subframe image data; driving a green channel with test image 100; and driving blue channel with blue subframe image data the RGB frame image can be noticeably greener colored on the right half of the image where the green light from the test image influences the combined image. Without DC compensation, the left half of the composite image where the test image in the green channel is dark can produce a darker left half of the RGB composite frame image. While the test image allows the microdisplay panel to be optically tested while the panel is displaying video, replacing the green channel with the test image introduces a DC imbalance into the microdisplay panel that would not otherwise be introduced by the video data.

Driving the red channel with DC compensating red subframe image data; driving the green channel with test image 100; and driving the blue channel with DC compensating blue subframe image data creates a DC compensated RGB frame image in which there is no DC offset introduced by the test image. By introducing the test image on one channel and DC compensating for the test image on one or more of the other channels, parameters of the microdisplay panel can be optically tested while a video image is being displayed on the panel without having the test image itself introduce an overall DC imbalance. The red subframe image data can include DC compensation which brightens the left side and darkens the right side of the red subframe image. Similarly, blue subframe image data can include DC compensation which brightens the left side and darkens the right side of the blue subframe image. The DC compensated red and blue subframe images in combination compensate for the darker left side and brighter right side of the test image in the green channel when test image 100 is used so that the test image does not introduce a DC imbalance into the microdisplay panel.

While the channels shown are the channels that are normally illuminated during display of a video image, other channels that are not normally illuminated may also be incorporated during the operation of the panel. For example, a red channel may be driven with a subframe while the red illumination source is on and then immediately afterwards driven with a negative of the subframe with the no illumination. This tends to DC balance the microdisplay panel although the time that an individual channel is driven with the positive image and is driven with the negative image does not have to be the same if a DC imbalance for the normal video is acceptable.

The overall DC balance of the liquid crystal pixels can result from the display drive voltages over the course of one or more frames. The test image introduced in one or more subframes can change the DC balance of the pixels when displaying a video stream, even if the video stream is already DC imbalanced. The amount that the DC bias voltage of a pixel is skewed, the DC offset, by replacing one or more subframes with the test image depends on the drive scheme being used as well as the color values in each of the video channels being input to the microdisplay. The degree by which the DC balance is skewed by the test image can depend on the difference between the grayscale values of the replaced video subframe(s) and the test image. Larger differences between the grayscale value of a given pixel in the test image and the grayscale value of the pixel of the replaced video subframe image can result in larger DC offsets.

In the 7-bit grayscale value display, for example, in which the video subframe for the green channel can be replaced with the test image, and the grayscale value for a given pixel in the test image is a 0 (black) while the grayscale value for the given pixel in the replaced video subframe is a 40, a shift in the DC bias offset will occur. Since the grayscale value of the pixel in the replaced video subframe is 40 out of a possible 127, the replaced video is already exhibiting a DC imbalance from the video. However, to correct for the shift in the DC bias introduced by the test image, one or both of the other two channels, the red and blue channels in this instance, can be modified to compensate for the grayscale reduction in the green channel. In this instance, where all channels are driven equivalently and the grayscale effects are linear, increasing the grayscale values of the pixel in each of the red and blue subframes by 20 grayscale values for a total of 40 can offset the DC imbalance created by the introduction of the test image. Either the red or blue subframes could increase the grayscale value to correct for the DC offset introduced by the test image. An exact calculation of the correct amount by which the video data in the non-test channels should be adjusted can be determined on a case-by-case basis. In addition, the calculation can be based on a detailed knowledge of the drive algorithm being used to modulate the electric fields inside the display panel as will be familiar to a person having ordinary skill in the art.

In some instances, the full DC bias shift introduced by the test image in the channel used for testing cannot be corrected fully, or not at all. For example, if a pixel in the original video subframe for the green channel displayed white (or each channel had a grayscale value of 127 in the case of 7-bit data), but the test data replaced the data in the green channel with a grayscale value of 0 (black), the red and blue channels could not be increased to offset the change since these channels are already at their maximum values. In these or other instances, it may not be necessary to use video that causes this situation to arise, the test where this situation exists may not be used. In an embodiment, DC offset compensation may be used in the compensating channels for more than one subframe and/or frames when the uncompensated data in these channels is no longer at a maximum or minimum grayscale value.

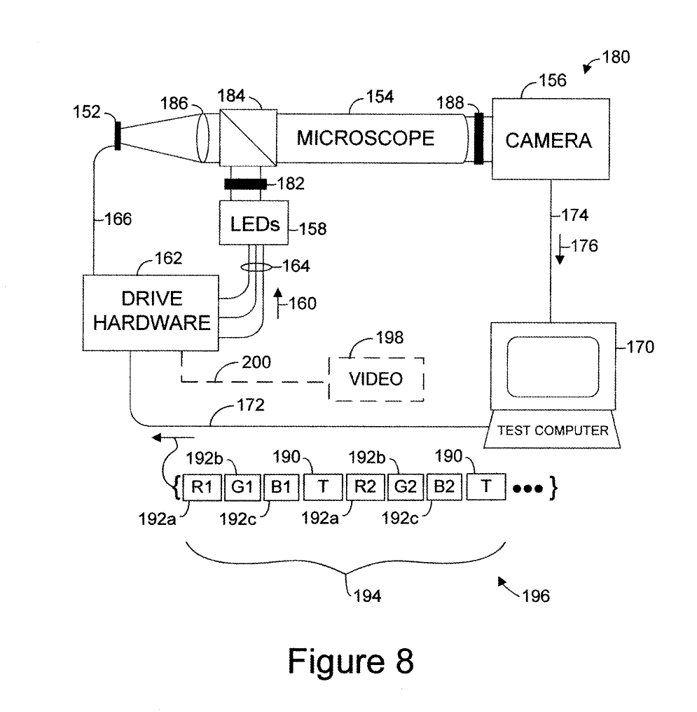

FIG. 8 illustrates an embodiment of an optical testing system generally indicated with reference number 180. Similar components in FIG. 8 are designated by reference numbers as seen in FIG. 7, accordingly, descriptions of these components are not repeated for purposes of brevity. Optical testing system 180 includes a polarizer 182 to polarize the light from light source 156. The polarized light enters a beam splitter 184 which reflects the polarized light to the microdisplay panel 152 through a lens 186. Light reflected from the microdisplay panel passes through the beam splitter and is optically imaged by the microscope. After passing through the microscope, the light reflected from the microdisplay passes to an analyzer 188 before entering test camera 156. Analyzer 188 can be included to increase contrast.

Optical testing system 180 illustrates an embodiment in which a separate test channel 190 is utilized for supplying the test image data to the microdisplay panel. In this embodiment, a red channel 192a, a green channel 192b, and a blue channel 192c can be used to compensate for DC imbalance introduced through test channel 190. Red, green and blue channels 192a-c along with test channel 190 can comprise a frame 194 of video and test data 196 which can be supplied to the drive hardware 162 from test computer 170 through test cable 172.

In some instances the video data can be synchronized with the camera system. In other instances, the video data does not require synchronization with the camera system. Where the video data does not require synchronization with the camera system, the testing video data can be provided from an isolated video playback source 198 over a separate video cable 200.

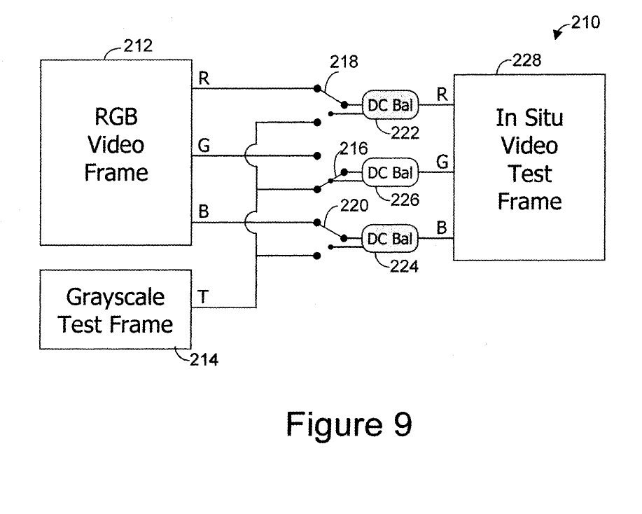

Referring now to FIG. 9, test frame generation is diagrammatically illustrated as indicated by reference number 210. Test frame generation can be accomplished through a hardware based system or can be implemented in software operating in the test computer or other device. A raw RGB video frame 212 can comprise the three channel (red, green and blue) source video frame data, for example, from use-model video. A grayscale test frame 214 can be a single channel image or video to be used for the camera-based test measurements. If a test image is used, the image data can be incorporated into every frame of the generated test video. In one embodiment, one channel (red, green or blue) of the RGB video frame can be replaced with the grayscale test frame, in another embodiment, two channels can be used to carry the test frame data. As shown, test frame generation 210 can selectively replace the green channel of the video with the test frame data through a software switch 216 while the original red and blue use-model video is routed through software switches 218 and 220. Because the replacement of one channel with a static image can cause a degradation of microdisplay performance due to DC imbalance effects, the use-model video can be processed in processors 222 and 224 to adjust for the DC imbalance effects. A processor 226 can be used for adjusting for DC imbalance effects in situations where the green channel is used for adjusting for DC imbalances. In the illustrated embodiment, the red and blue channels can be processed to compensate for the difference between the original green channel data and the test data to produce an in situ video test frame 228. For example, if one region of the test image is brighter than the original green data, the same region of the red and blue channels can be made darker to maintain an average gray level that is similar to or equal to the original data.

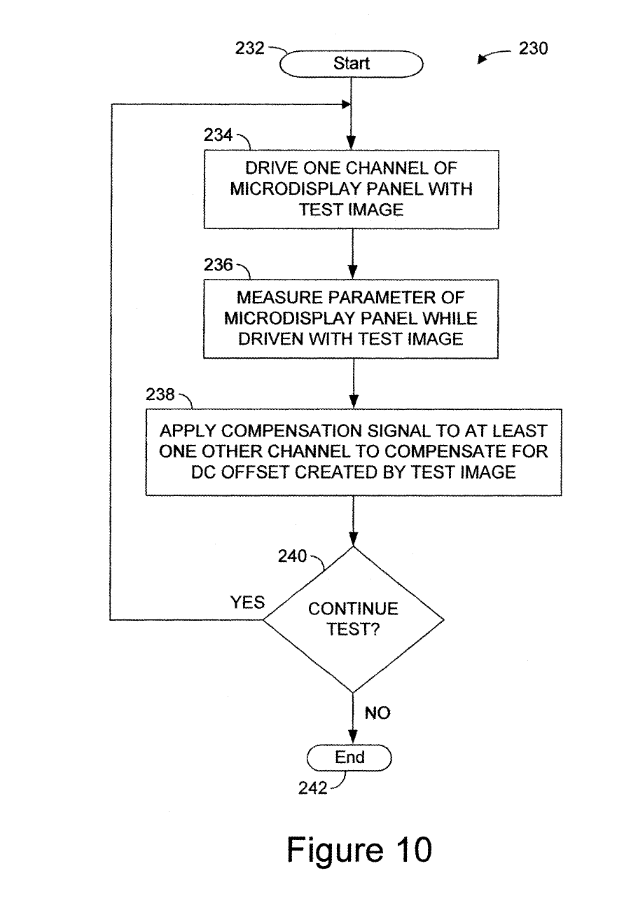

Turning now to FIG. 10, a flow diagram illustrates an embodiment, generally designated by the reference number 230, of a method for testing a microdisplay panel. Method 230 begins at a start 232 and proceeds to 234 where a channel of a microdisplay panel is driven with a test image. Method 230 then proceeds to 236 where a parameter of the microdisplay panel is measured while the panel is driven with the test image. Method 230 then proceeds to 238 where a compensation signal is applied to a different channel of the microdisplay panel to at least partially compensate for DC balance offsets in the panel created by driving the panel with the test image. Method 230 then proceeds to 240 where a decision is made as to whether the testing is complete. If the decision at 240 is that the testing is not complete, then the method returns to 234. If the decision at 240 is that the testing is complete then the method proceeds to 242 where the method ends.

In addition or as a replacement for the test images shown in FIGS. 5 and 6, other test images can also be used for measuring or determining parameters of the microdisplay panel, including test images produced by standards institutions such as, for instance ANSI. For instance, one or more subframes on one or more channels can be replaced with a full frame, flat black test image that can be used for measuring the dark level of the microdisplay panel and/or for optimizing the liquid crystal extinction angle. A full frame, flat white test image can be used for measuring throughput and/or brightness. Alternating black and white full frame test images can be used for measuring contrast and/or brightness. Alternating black and white full frame test images is an example of a dynamic test image. In contrast, when the test image is not changed from frame to frame, the test image can be referred to as a static test image. In some circumstances, such as when using alternating black and white full frame test images, the camera or other optical detection device can be synchronized with the test images so that the dark frames can be used for some tests and the bright frames can be used for other tests while the other channels are driven with video data.

Using the testing method described herein, the microdisplay can be tested in an in situ arrangement. The in situ display testing procedure can be performed while the microdisplay panel is operating in a mode consistent with the product use model. In this situation, the testing parameters are intended to emulate the conditions expected to be encountered by the display in the final product. This testing procedure can include parameters such as physical conditions (e.g., temperature and light exposure) and the video media being displayed during the testing (e.g., movie, photo slideshow, or business presentation content). The in situ testing method can be minimally invasive in that only one of the channels in the video data stream is replaced with the test image, so that the other channels can continue to display use model video content, which impacts the performance of certain types of LCD displays, including FLCOS displays.

By using the testing method described herein the sequential microdisplay panel can be tested while it is driven with use-model video footage. Use-model video footage can be any typical video data that would be sent to the display panel by a particular end-user, including movies, web video clips, photo slideshows, and business presentations. The panel may be set up differently for performance based on the measured parameters determined during in situ testing with use-model video that the particular panel may be used to display. The performance of the panel can be optimized or otherwise customized for the use-model video that a customer intends to display with the panel. The use-model video can be representative of the type of content with which the display will be used, or can be the exact content. For example, use-model video for a business presentation can be photo slide shows, business presentations, or power point presentations which can typically have a white background with text letters that are not moving. In comparison, a use-model for video could be a movie in which can contain generally more dark images.

One parameter that can be used for optimizing performance is the buff angle. In ferroelectric liquid crystal (FLC), the level of darkness achievable can rely on the angle of the liquid crystal when it is turned off. To optimize the FLC to display black, the angle of the liquid crystal in the off state has to be lined up with the polarizers. The actual physical characteristic of the liquid crystal is the direction that the liquid crystal is pointed with a given electric field. If the liquid crystal pixel is not operating in DC balance, the field that is applied to the pixel is going to be different depending on the type of video applied. Accordingly, if the liquid crystal angle can be lined up with the polarizer for a particular DC imbalance caused by the use-model video, the optical performance of the panel can be improved. In addition, by knowing the type of video used, other corrections can be made to optimize the panel for that type of video. For instance, by knowing the type of video to be used, shifts in the DC balance can be determined and the drive voltage can be adjusted during display of the type of video to compensate for the shifts.

While some embodiments can use a single channel for the test image and multiple channels for compensation, other embodiments can use one channel for the test image and one channel for compensation, or multiple channels for test images and one or more channels for compensation. Although the green channel was used by way of a non-limiting example for handling the test image, it should be appreciated that the red and/or blue channels can be used for the test image. The test image can also be used in a dedicated test image channel which does not correspond to one of the usual red, green or blue subframe divisions of the frame. In this instance, for example, the frame can be divided into eight total subframes, with six subframes for the red, green and blue channels and two subframes for the test image. The time divisions of the frame allotted to each of the subframes do not necessarily have to be equal to one another. For instance, if the test image is driven on the green channel for twice the time that the red and blue channels are driven with the video subframes, then the red and blue channels can be adjusted to compensate for increased impact that the test image has on the DC offset introduced by the increased time that the panel is driven with the test image.

The foregoing descriptions of the invention have been presented for purposes of illustration and description. It is not intended to be exhaustive or to limit the invention to the precise form or forms disclosed, and other modifications and variations may be possible in light of the above teachings wherein those of skill in the art will recognize certain modifications, permutations, additions and sub-combinations thereof.

What is claimed is:

1. A method comprising:
driving a microdisplay panel using a test image signal through one channel of a plurality of channels while illuminating the microdisplay panel;
measuring a parameter of the microdisplay panel while the panel is illuminated; and
applying a compensation signal to at least one of the other channels to at least partially compensate for DC balance offsets in the microdisplay panel created by driving the microdisplay panel with the test image signal.

2. The method of claim 1 further comprising applying the compensation signal while the microdisplay panel is not illuminated.

3. The method of claim 1 further comprising driving the microdisplay panel with the test image signal in situ while the microdisplay panel is a component of a microdisplay device.

4. The method of claim 1 further comprising producing the compensation signal by modifying use model video data.

5. The method of claim 1 further comprising driving the one channel with the test image signal and applying compensation signals to two other channels.

6. The method of claim 1 further comprising driving the one channel with the test image signal and the other channels are red, green and blue channels.

7. The method of claim 1 further comprising configuring the test image signal to include test image data of a standard test pattern.

8. The method of claim 1 further comprising configuring the test image signal to include test image data of a bisected test pattern.

9. The method of claim 1 further comprising configuring the test image signal to include test image data that is static.

10. The method of claim 1 further comprising configuring the test image signal to include test image data that is dynamic.

11. A method for testing a microdisplay panel in a microdisplay device having red, green and blue channels for receiving red, green and blue video data signals, respectively, to sequentially drive the microdisplay panel at a rate sufficient to visually mix the colors, the method comprising:
driving the microdisplay panel using a test image signal through one of the channels;
measuring a parameter of the microdisplay panel while the panel is driven with the test image signal; and
applying a compensation signal that includes compensation data to at least one of the other channels to at least partially compensate for DC balance offsets in the microdisplay panel created by driving the channel with the test image signal.

12. A method for testing a microdisplay panel comprising:
applying a test image signal to a first channel of the microdisplay panel, the test image signal introducing a DC offset in at least one pixel of the display;
obtaining test information while the test image signal is applied to the first channel of the microdisplay panel;
supplying compensation data to at least one other channel of the microdisplay panel subsequent to applying the test image signal to the first channel, the compensation data at least partially correcting for the DC imbalance introduced into the pixel by the test image signal.

13. A method of claim 12 further comprising illuminating the microdisplay panel while applying the test image signal to the first channel.

14. A method of claim 13, wherein the test image signal comprises test data and further comprising configuring the compensation data based at least partially on the test data.

15. A method of claim 14 further comprising configuring the compensation data based in part on use model video data.

16. A method for testing a microdisplay panel comprising:
driving one channel of a plurality of channels of the microdisplay panel with a test signal for characterizing at least one optical performance parameter of the panel such that the test signal produces a DC offset in the microdisplay panel over time that influences a measured value of the optical performance parameter over time; and
applying a compensation signal to at least one different channel of the plurality of channels, the compensation signal at least partially correcting for the DC imbalance introduced into the pixel by the test image signal.

17. A method for testing a microdisplay panel comprising:
driving one channel of a plurality of channels of the microdisplay panel with a test signal for characterizing at least one optical performance parameter of the panel such that the test signal produces drift in a measured value of the optical performance over time; and
applying a compensation signal to at least one different channel of the plurality of channels, the compensation signal at least partially reducing the drift over time.
